(19) United States
(12) Patent Application Publication
(10) Pub. No.: US 2007/0028262 A1
(43) Pub. Date: Feb. 1, 2007

(54) Virtual discovery of content available to a device

(75) Inventors: Timothy Bucher, Los Altos, CA (US); Mark A. Ross, San Carlos, CA (US); Timothy C. Nichols, Los Altos, CA (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: Zermatt Systems, Inc.

(21) Appl. No.: 11/193,828

(22) Filed: Jul. 29, 2005

(51) Int. Cl. H04N 7/025; G06F 13/00; H04N 7/10; H04N 7/173; H04N 5/445; G06F 3/00

(52) U.S. Cl. 725/34; 725/35; 725/46; 725/113

(57) ABSTRACT

Discovering content on data streams available to a device such as a satellite radio. A satellite radio may be able to receive channels from a satellite network as well as over an IP-based network. The device can be configured to tune multiple channels selected from the channels available to the device over these networks based on the user's preferences. The user preferences can be compared to at least the metadata of the channels available to the device in order to identify the channels that best match the user's preferences. The channels identified in this manner are then tuned and recorded on the device. A user may then be notified of the recorded content.

### CROSS-REFERENCE TO RELATED APPLICATIONS

Not applicable.

### BACKGROUND OF THE INVENTION

1. The Field of the Invention

The present invention relates to discovering content on a device. More particularly, embodiments of the invention relate to tuning digital media content on a portable audio device.

2. The Relevant Technology

Digital media and digital media devices are becoming ubiquitous in today's society. Many of these devices that can perform digital media are portable devices with wireless capabilities. The increasing availability of digital media and the strong demand for portable devices corresponds with a growth in wireless network technology and the ability to distribute digital media. As a result, digital media can be received, for example, over many different networks and protocols.

One of the more recent technologies used to deliver digital content is satellite radio. In satellite radio, a satellite or satellites broadcast digital radio content to people that have subscribed to the content. Through satellite radio, subscribers can receive high quality, uninterrupted, digital media content such as radio content over many different channels. The digital media transmitted over satellite radio can include, by way of example, digital quality music, talk radio, sports, news, weather, and the like. In order to take advantage of the content offered over satellite radio networks, a user of satellite radio needs a portable device that can receive and ultimately play or perform the digital media content.

While satellite radio has the ability to deliver content over many different channels to multiple users, a user with a satellite radio can only listen to one channel at a time. As a result, all of the channels that are not being performed are undiscovered content from the perspective of the user's device. At the same time, the other channels are still being broadcast over the satellite network and are available to the user's satellite radio. A user can easily tune his or her satellite radio to another channel. Even though a user can tune to another channel, the remaining channels are still presenting undiscovered content to the user.

Enabling users to discover content on other channels available or capable of being received by the user's satellite radio is beneficial to both the recipient of the content and those that provide the content. For example, user feedback on the content being delivered over the satellite network can be used to improve service or to tailor the content to the desires of the relevant audience. Enabling users to discover new content on other channels can improve or increase the size of the audience as well. At the same time, the discovery of content can also result, for example, in increased revenues for the content providers, increased market share, and improved ratings.

### BRIEF SUMMARY OF THE INVENTION

These and other limitations are overcome by embodiments of the present invention, which relates to systems and methods for discovering content and more particularly to discovering the content on all or some of the channels that are available to a device over multiple networks. In one embodiment, a satellite radio receives channels from a satellite network as well as over an IP-based network. The channels available over the IP-based network may need to be requested by the device to initiate transmission of the channels to the device over the IP-based network. The satellite radio can then tune multiple channels based at least on preferences of the user such as preferred channels, preferred type of digital content (talk, music, sports, etc.), music genre, artist, and the like or any combination thereof. Tuning the channels may include identifying those channels that have content that at least partially matches the user's preferences by comparing the metadata in the various channels with the user's preferences. The channels identified in this manner are then tuned and recorded on the device. A user may then be notified of the recorded content.

In one example, a method for discovering content on the channels begins by receiving the data streams available to the device. The data stream from the satellite network may include multiple channels, while multiple channels can be requested over an IP network when the IP network is available to the device. Next, the channels are processed using the user's preferences to identify certain channels that best match the user's preferences or that partially match the user's preferences. The content discovered in this manner can be recorded on the device. The user can then be notified of the recorded content.

Additional features of the invention will be set forth in the description that follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates an exemplary device that can tune and record content from multiple sources;

FIG. 2 illustrates an exemplary device that can discover and record multiple channels of content from multiple content sources; and

FIG. 3 illustrates an exemplary method for recording undiscovered content.

### DETAILED DESCRIPTION OF THE PREFERRED EMBODIMENTS

Embodiments of the invention relate to discovering content and more particularly to systems and methods for preserving undiscovered content for a user. In one embodiment, a satellite radio or other device may be able to receive channels from several different sources such as a satellite network and/or an IP-based network. The satellite radio or other device tunes multiple channels that are selected from the channels available to the device over these networks. The specific channels tuned may be based on the user's preferences. The user's preferences, for example, may be compared to at least the metadata of the content in the channels available to the device in order to identify the channels that best match the user's preferences. The channels selected in this manner are then tuned and recorded on the device. A user may then be notified of the recorded content.

In satellite radio, for example, a user can only listen to a single channel or data stream at a time even though the satellite radio system may be broadcasting multiple channels or data streams. Therefore, channels not being listened to or being performed by the satellite radio are undiscovered content from the user's perspective. Embodiments of the invention discover the content in some or all of the channels available to a user or a user's satellite radio (or other device) and enable the user to experience the content at a later time. A user's device can virtually tune other channels available to the device to store content on those channels.

Portable devices, such as digital audio devices (e.g., MP3 players), CD players, DVD players, notebook computers, cellular telephones, satellite radios, and personal digital assistants, are within the scope of the present invention. Less portable or non-portable device such as desktop computers and other network enabled devices are also within the scope of the invention. Embodiments of the invention also enable one or more devices to work together such as a device and a computer where the device docks or between devices.

In one embodiment, the user's device is a satellite radio that receives digital media content from at least a satellite network and may be able to receive content from other networks. A satellite network broadcasts multiple channels. A satellite radio can tune to one of those channels and perform the content on the tuned channel. Embodiments of the invention can record or store (permanently or temporarily) content on the other channels as well as the tuned channel for review or use by the user. In other words, the other channels in the satellite broadcast can also be tuned and recorded by the device while another channel is being played. Multiple channels can be tuned and recorded when the device is not being actively used by a user as well. The determination of which channels to record can be dependent on device settings and/or user preferences.

Tuning the data stream broadcast by satellite radio may include identifying the content associated with a particular channel. In one embodiment, the content is represented by packets. The identified content, which may be represented by packets, can be performed by the satellite radio. When another channel is selected, packets associated with the content of that channel can be identified and performed.

Although embodiments of the invention are discussed with reference to satellite radio networks, one of skill in the art can appreciate that embodiments of the invention can be applied to other networks (wired and/or wireless) over which content is delivered. Cellular networks, IP-based networks, WiFi networks, Bluetooth networks, and the like or any combination thereof are examples of networks over which content can be discovered in accordance with embodiments of the invention.

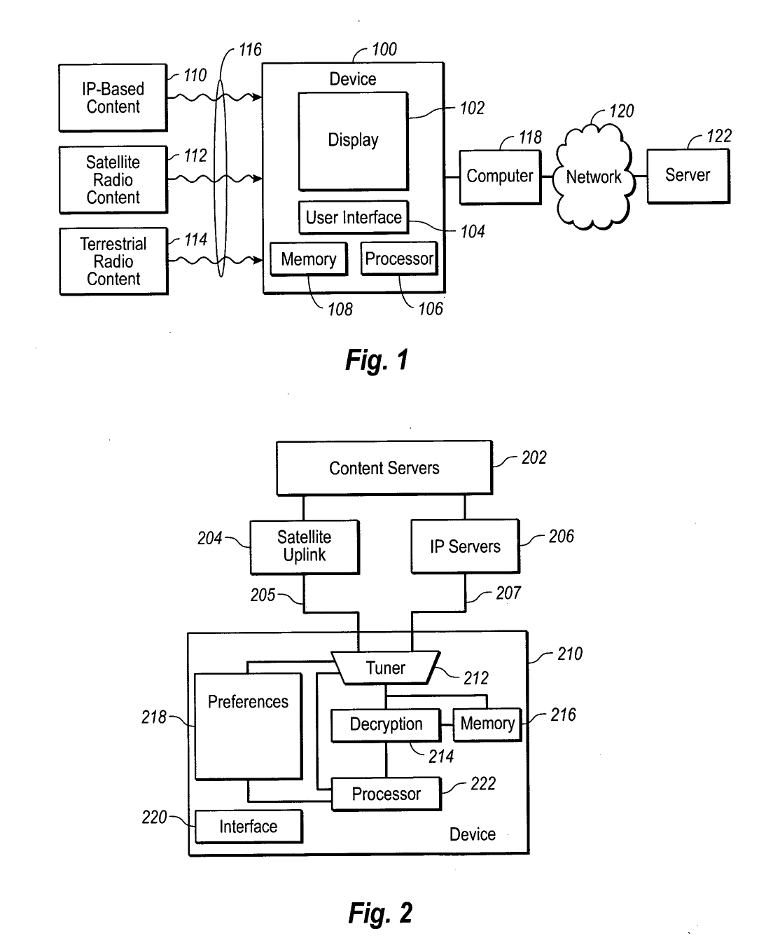

FIG. 1 depicts an exemplary environment for implementing embodiments of the invention and illustrates one embodiment of a device that can receive content including digital media from one or more sources. In this example, the device 100 is representative of both portable and non-portable devices that can receive content 116 that may include digital audio and/or digital video data. Examples of the device 100 may include, by way of example, a satellite radio device, a portable audio player (e.g., an MP3 player), a portable DVD or CD player, a personal computer, a laptop computer, a cellular telephone, a personal digital assistant, and the like or any combination thereof.

Typically, the device 100 includes a display 102 that can convey information to the user of the device regarding the content stored on the device 100 and/or related to content being performed by the device 100 and/or received by the device 100. For example, when the device 100 performs digital audio data, the display 102 may convey the song title, the name of the artist, the album title, the track number, the length of the track, and the like or any combination thereof. The device 100 also includes a user interface 104, which may include control buttons or other means of providing input to the device 100. The user interface 104, by way of example, enables a user to navigate and perform the digital media that is stored in the memory 108 of the device 100 or to navigate and perform any content or data stream that is received from an external source or over any network that is compatible with the device. The user interface 104 may also enable a user to switch to another channel such as in satellite radio.

The device 100 includes a processor 106 used by the device in receiving, processing, and/or performing the content received over the channels 116 (also referred to as a data stream(s)) available to the device 100. The channels 116 represent different types of media or data streams including digital media content that may be received by the device 100. Examples of the channels 116 include, but are not limited to, digital music, talk audio data, television data, movie data, podcasts, sports data, and the like or any combination thereof. The channels 116 can be either digital or analog in nature.

In this example, the device 100 may be able to receive content generated by various content providers. Examples of the content include the IP-based content 110 that may be received over an IP-based network, the satellite radio content 112 that may be received over a satellite radio network, and the terrestrial radio content 114 that may be received over a terrestrial radio network. One of skill in the art can appreciate that content can be received over other networks including cellular networks. In addition, content or other data can also be transmitted by the device 100 in some of these networks. A satellite radio device typically receives content from a satellite network, although the satellite radio device may also be configured to connect with and receive content over other networks or from other content providers as illustrated in FIG. 1.

The memory 108 of the device can be used to store content or other user and/or device data. The memory 108 can also be used to record content that is received from the content providers or obtained from another source. The memory 108, for example, may store digital music and/or video, graphics, playlists, user preferences, device settings, and the like or any combination thereof.

The device 100 may also be adapted to dock with another device such as the computer 118. Once docked with the computer 118, the device 100 may be able to synchronize the digital media stored in the memory 108. In addition, the device 100 may be able to communicate with a server 122 over the network 120 in order to secure the rights or to purchase content that may have been stored in the memory 108 according to embodiments of the invention. Although FIG. 1 illustrates that the device 100 communicates with the server 122 through the computer 118, the device 100 may be able to detect and communicate with the server 122 or other devices over other networks including wireless networks such as 802.11 based networks, Bluetooth networks, or the like. The device 100 may be able to communicate with the server 122 without being docked to the computer 118.

FIG. 2 illustrates exemplary systems and methods that may be employed in making content available to a device or in discovering content. In this example, a content provider such as a satellite radio system may use content servers 202 to prepare the content that is delivered via the satellite system. The content servers 202 can then deliver the prepared content (for all channels broadcast by the satellite system) to a satellite uplink 204. Through the satellite uplink 204, the prepared content is delivered to the satellite system. The prepared content is then broadcast by the satellites in the satellite system. The delivery of the prepared content to satellite radios may also involve the use of terrestrial repeaters.

The device 210, which is one embodiment of the device 100, receives content prepared by the content servers 202 with a tuner 212. The tuner 212 identifies the packets or other data associated with the channel currently selected by the user. The operation of the tuner 212 is related to the characteristics of the content received over the satellite system. For example, the digital content may be carried on an analog signal that the device 210 must first acquire. The tuner 212 may therefore have the ability to lock onto the satellite signal and extract the digital data from the satellite signal. The digital data is then further processed by the tuner 212 and the processor in order to identify those packets that are specific to the channel currently selected by the user. In this manner, the tuner 212 can select a particular channel from the satellite broadcast for performance by the device 210. Performing the selected channel may include the device 210 performing decryption 214 on the tuned content. The tuned content may also be recorded in the storage 216. In recording the tuned content, the device 210 may reduce the quality or simply store metadata identifying the tuned content.

The device 210 also has the ability to discover content on other channels in the satellite stream 205. In addition to tuning and performing the channel currently selected by the user, the device 210 can tune other channels in the stream 205 and then record those channels without performing those channels. This can occur even when the user is not actively using the device 210. Because the ability of the device 210 is often limited by the size of the memory 216, the amount of content that can be recorded from the channels available to the device 210 is limited.

For example, the device 210 could record the content on all of the channels available over the stream 205. In one embodiment, the device 210 uses preferences 218 to select particular channels. A user, for example, can identify specific channels whose content should be recorded. In another embodiment, the device 210 can monitor the usage habits of the user and then record those channels that the user commonly selects. By reducing the number of channels that are being recorded by the device 210, more content can be recorded for each channel. The preferences 218 can include, by way of example, a user's favorite channels, preferences including channel lists of other users or received from other devices, preferred artists or songs, genres, type of content (i.e., talk, sports, music, etc.) and other information that can qualify or describe content. User preferences 218 can be used to select channels from the channels available to the device. Selecting channels using the user preferences may include, by way of example and not limitation: selecting the one or more channels based on preferred channels identified by a user of the device; selecting the one or more channels based on one or more artists; selecting the one or more channels based on one or more genres; selecting the one or more channels based on preferences on another user or from another device; or selecting the one or more channels based on a playlist stored in the device, and the like or any combination thereof.

Using these preferences, the device 210 can examine the other channels (including the metadata) for content that matches or that has a strong correlation with the user's preferences 218. As a result, a channel that includes content from a particular artist in the user's preferences may be recorded. Alternatively, a channel that includes content from another user's artist list may be recorded. In one embodiment, the preferences or at least a portion of the user's preferences are compared at least to metadata associated with the content of the channels available to the device. The channels that best match or that have the highest correlation with the user's preferences are selected for recording. In one embodiment, the number or channels selected to record may be limited based on the memory available in the device and the estimated recording time that is available. In other words, it may be preferable to record 2 hours of 4 channels rather than 30 minutes of 16 channels.

The user interface 220 can be used to configure the preferences 218 in order to configure the tuner 212 to identify channels on the data stream 205 that match the preferences 218.

After the virtually tuned channels are recorded, the user may be notified of the recorded content. The device 210 may automatically acquire rights to the acquired content as well by contacting the appropriate server (such as the server 122 illustrated in FIG. 1, for example) when within range of an appropriate network. In one embodiment, the recorded content in the memory 216 may or may not be encrypted and may or may not be compressed. In other words, the device 210 can decrypt and/or compress the content being recorded. Compressing the content increases the amount of content that can be recorded.

FIG. 2 further illustrates that the content providers 202 can deliver the same or different content through IP servers 206 (or through another wireless or wired network). When the device 210 is within range of an appropriate network, the device 210 may be able to receive the channels prepared by the content providers 202 from the IP servers 206. There may be instances, for example, where the content is not available over the satellite network (e.g., the signal from the satellite network is blocked or the device is not within the coverage area of the satellite network). In this case, the device 210 may be within range of an IP-based network that carries the prepared content from the content servers 202. The device 210 may able to receive both the stream 205 from the satellite network as well as the stream 207 from the IP-based network.

In this example, the stream 207 is an IP-based stream that is delivered over an appropriate wireless and/or wired network. The device 210 receives the data stream 207. Because the content of the data stream was prepared by the content servers 202, it may be the same as the content delivered through the satellite uplink 204. The ability of the device 210 to receive content from the IP servers 206 may depend on bandwidth, for example.

To record the content, the device 210 can communicate with the IP servers 206 to request data for specific channels. The selected channels can be delivered to the device 210, which can store the content in the memory 216. Thus, the device 210 is able to record the selected content from the content servers 202 even when the device 210 cannot receive the satellite content over the satellite network. The content requested from the IP servers 206 may be dependent on the preferences 218 as previously described.

For example, the device 210 can send a request for those channels that match certain aspects of the preferences 218. The IP servers 206 can then identify the channels that satisfy or at least partially satisfy the requirements of the user's preferences 218 and stream the relevant channels to the device 210. Alternatively, the device 210 may be able to request one or more streams from the IP servers until a stream that satisfies the user's preferences is discovered. In one embodiment, the device 210 may be required to request the prepared content from the IP servers 206, unlike the data stream from a satellite network which is simply broadcast.

The stream 207 may be encrypted as well. This can ensure that only authorized devices have the ability to receive and perform content from the IP servers 206. Thus, embodiments of the invention can preserve the content authorization (CA) that is typically present, for example, on satellite radios.

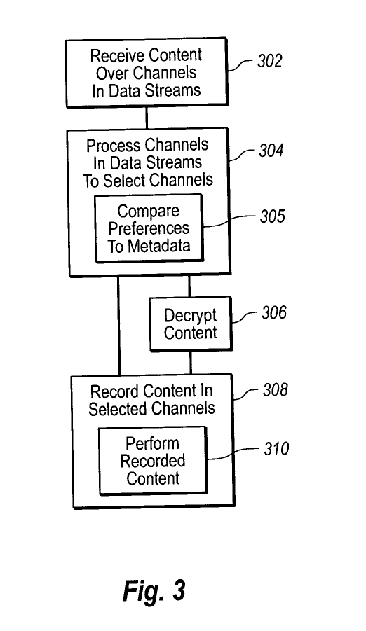

FIG. 3 illustrates an exemplary method for discovering content. A device such as the device 100 or the device 210 can receive 302 content. In the case of a satellite broadcast, the device automatically receives all of the channels being broadcast by the satellite system. The device is then required to tune to a particular channel to perform. The ability of the device to tune to a particular channel may be dependent on the user's subscription as the content is usually encrypted. In the case of an IP-based network, receiving the content may require the device to detect an appropriate network and then request the content from content servers.

As the content is received, the device may examine or process 304 multiple channels. As previously described, the content of channels included in the data stream or in channels is compared 305 to the user's preferences in one embodiment. Those channels in the streams that match or partially match the user preferences can be recorded by the device. Once the ability of the memory to record content is exhausted, the device may stop recording content or may begin overwriting older content. In the case of content from an IP server, the device may request certain channels directly from the servers. After the channels are selected, the content in the selected channels is recorded 308 and may be performed 310 at a later time.

If necessary, the device may decrypt 306 the content before it is recorded. Alternatively, the device may record the encrypted content. If the recorded or stored content is encrypted, it is decrypted when it is played or performed on the device by the user. Optionally, the device can automatically secure the rights to the recorded content and then obtain a higher quality version of the content, for example.

In another embodiment, the device can record the metadata associated with the content of the channels available to the device. Later, the device can then download the content based on the metadata. This enables a user to record the content on more channels using less space. Only the content that the user selects is obtained at a later time.

Embodiments within the scope of the present invention also include computer-readable media for carrying or having computer-executable instructions or data structures stored thereon for performing embodiments of the invention. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

The following discussion is intended to provide a brief, general description of a suitable computing environment in which the invention may be implemented. Although not required, the invention will be described in the general context of computer-executable instructions, such as program modules, being executed by computers in network environments. Generally, program modules include routines, programs, objects, components, data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those skilled in the art will appreciate that the invention may be practiced in network computing environments with many types of computer system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a system including a device that receives content from one or more data stream sources, a method for discovering content in the data streams, the method comprising:
receiving one or more data streams from at least one content source, wherein the one or more data streams includes digital content;
selecting one or more channels in the one or more data streams based on preferences of a user of the device; and
recording the selected one or more channels in a memory of a device.

2. A method as defined in claim 1, wherein receiving one or more data streams further comprises one or more of:
receiving the one or more channels in a satellite broadcast; and
receiving the one or more channels from an IP-based server over an IP-based network.

3. A method as defined in claim 1, wherein selecting one or more channels in the one or more data streams further comprises tuning to the device to a particular channel.

4. A method as defined in claim 1, wherein selecting one or more channels in the one or more data streams further comprises tuning the selecting one or more channels.

5. A method as defined in claim 1, wherein selecting one or more channels in the one or more data streams further comprises one or more of:
selecting the one or more channels based on preferred channels identified by a user of the device;
selecting the one or more channels based on one or more artists;
selecting the one or more channels based on one or more genres;
selecting the one or more channels based on preferences on another user or from another device; or
selecting the one or more channels based on a playlist stored in the device.

6. A method as defined in claim 1, wherein selecting one or more channels in the one or more data streams further comprises comparing the preferences of the user to metadata associated with channels included in the one or more data streams.

7. A method as defined in claim 1, further comprising securing rights to the recorded one or more channels without user input.

8. A method as defined in claim 1, wherein recording the selected one or more channels further comprises reducing a number of channels being recorded based on the remaining memory of the device.

9. A computer readable medium having computer executable instructions for performing the method of claim 1.

10. In a system including a device that receives multiple channels from one or more sources, a method for discovering content on the channels, the method comprising:
receiving one or more data streams, wherein at least one data stream includes one or more channels broadcast over a satellite network, each channel having content;
processing the one or more channels based at least on preferences of a user of the device to discover content that at least partially matches the preferences; and
recording selected channels that at least partially match the preferences.

11. A method as defined in claim 10, wherein processing the one or more channels based at least on preferences of a user of the device further comprises one or more of:
selecting one or more preferred channels included in the preferences;
selecting one or more playlists included in the preferences;
selecting one or more artists included in the preferences; and
selecting additional preferences received from another user.

12. A method as defined in claim 10, wherein processing the one or more channels further comprises limiting a number of the one or more channels based on available memory of the device and estimated recording time.

13. A method as defined in claim 10, wherein processing the one or more channels further comprises limiting a number of the one or more channels based on the available memory bandwidth of the device.

14. A method as defined in claim 10, wherein processing the one or more channels further comprises comparing the preferences at least with metadata included with content of each of the one or more channels.

15. A method as defined in claim 14, wherein processing the one or more channels based at least on preferences of a user of the device further comprises selecting the one or more channels based on at least a partial match between the preferences of the user and at least metadata of the one or more channels.

16. A method as defined in claim 10, wherein recording the channels further comprises notifying the user of the device regarding the recorded channels.

17. A method as defined in claim 10, wherein receiving one or more data streams further comprises
sending the preferences to a server over an IP-based network, wherein the server identifies the selected channels; and
requesting the selected channels over the IP-based network.

18. A method as defined in claim 17, wherein the selected channels over the IP-based network and over the satellite network are encrypted.

19. A method as defined in claim 10, wherein receiving one or more data streams further comprises tuning the device to a particular channel and performing the particular channel, wherein the particular channel is not included in the recorded selected channels.

20. A computer readable medium having computer executable instructions for performing the method of claim 10.
